(19) United States
(12) Patent Application Publication
(10) Pub. No.: US 2002/0188634 A1
(43) Pub. Date: Dec. 12, 2002

(54) Method to provide pre-selected information

(75) Inventors: Adolf Proidl, Vienna (AT); Markus Mueller, Bad Fischau (AT)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/161,750

(22) Filed: Jun. 4, 2002

(30) Foreign Application Priority Data
Jun. 6, 2001 (EP) 01 890 177.7

(51) Int. Cl. G06F 15/00

(52) U.S. Cl. 707/513

(57) ABSTRACT

The invention relates to a method and a computer device (1) to provide pre-selected information from at least one data network (4), in particular the Internet, for querying by a user terminal (6), in which certain data sources (3) offered by selected suppliers in the data network (4), in particular websites, are queried and particular contents of these data sources (3) stored, which contents are queried by input or selection of search terms referring to desired products, services or information from suppliers and can be output via the terminal (6). In addition to the database (5) for the contents of the data sources (3), a database (7) can be provided for storing user-specific data entered via the terminal (6). In addition, a database (8) can be provided for storing statistical data. To secure the connection (9) between the terminal (6) and the computer device (1), devices (10) can be provided for encryption and decryption of the information transferred. The method and computer device (1) according to the invention provide particular data from a multiplicity of data sources (3) to the user of a terminal (6) and thus facilitate the finding of particular products, services or information in the data networks (4), in particular the Internet.

The invention relates to a method to provide pre-selected information from at least one data network for querying by a user terminal. The term “data network” in particular relates to the Internet, although various other data networks such as intranets, telephone networks or the like are also possible. The term “terminal” means various devices by which a user can communicate with the data network or data sources included in the data network. These are in particular so-called CE (Consumer Electronics) devices which allow access to the content of data networks by means of corresponding hardware and software. Ever more domestic appliances such as TVs and their attachments such as video recorders or DVD players, but also digital cameras, mobile phones, fax machines or even special watches, today offer the facility of communication with data networks, in particular the Internet. As well as devices which are mainly used in the private range, the term “terminal”, however, also includes industrial equipment.

The invention further relates to a computer device to provide pre-selected information from at least one data network, in particular the Internet, for a user terminal to query.

The invention further relates to a computer program product which can be loaded in the memory of a digital computer and comprises software code sections.

Because of the world-wide connection of the most varied data sources via data networks, in particular the Internet, the amount of information offered via the data network is constantly increasing. In electronic commerce the number of goods and services offered is constantly increasing so it becomes ever more difficult for the consumer to find, from the wealth of goods and services offered, that most suitable for him within a reasonable time. But not only in the field of electronic commerce but also for pure information it is becoming ever more difficult to select the most appropriate information from the wealth of possible data.

On the Internet it is normal to search for data sources offering the desired information using search engines. Particular search terms are entered and data sources known as websites are searched using these search terms. More often than not, tremendously long hit lists are found which make subsequent selection of the sites found a lengthy method or even impossible within a reasonable period of time.

Furthermore, EPG (Electronic Program Guide) servers are known which search the Internet for data sources that contain program information on television or radio broadcasts and store this program information in their own databases. To support for example the programming of a video recorder, the information present in the database of the EPG server can be loaded to the memory of the video recorder.

WO 00/70521 A2 describes a method and a device to facilitate electronic commerce on the Internet from a personal computer. To this end the keyboard has extra keys to which are allocated certain websites on the Internet. When one of these keys is activated, the corresponding display program, i.e. the Internet browser, is started automatically and the corresponding website loaded. The key allocation is managed by a company, where the linking of user-specific data or demographic data is possible. In this method the user is offered a particular data source or website which is sometimes tailored to user-specific data or demographic data. Said method does not offer a selection of different data sources or websites containing the product or information desired by the user.

The invention therefore has for an object to create a method and a computer device to provide pre-selected information from at least one data network, in particular the Internet, for querying by a terminal of a user, whereby a selection of information from various data sources in the data network corresponding to the user's wishes is provided to the user and the user need merely choose from a manageable quantity of information. The method and computer device allow an expansion of or change to the pre-selection performed and is characterized by maximum ease of use. In addition the method or computer unit can correspond to the wishes of users already known and hence, without action by the user, perform a user-specific pre-selection of the information offered.

To achieve this object it is proposed with regard to the method that certain data sources offered by selected suppliers in the data network, in particular websites, are queried and particular contents of these data sources stored, which contents can be queried and output by the terminal after input or selection of search terms referring to desired products, services or information from suppliers. This avoids for the user the lengthy and often difficult search for data sources in the data network which offer the products, services or information desired by the user, while the latter can find, acquire, use or assess the product, service or information more quickly.

The method however also helps suppliers bring their products, services or information to a user in a more targeted manner. For example, after entering the search terms “eating” and “Italian” or after selecting correspondingly offered terms, the user can be offered all pizza services on the Internet which are situated in the locality of the user's terminal, for example of a personal computer. Consequently, the user need not know the Internet addresses of various pizza services in his area. Pre-selection is performed for the user by the present method. The operator of the method described continuously updates each data source in the data network that is queried and its contents stored so that the user can always be supplied with current and correct information.

Advantageously the data sources selected are searched periodically, so that the stored information is constantly updated. The intervals between queries can be shorter or longer depending on the necessity for and topicality of the information provided. The query of data sources preferably takes place at times of reduced data traffic or at which reduced data transfer costs apply.

If in addition to the content of the data sources user-specific data is entered and stored via the terminal, an even more targeted pre-selection of the information offered can be achieved. In the example given above of the pizza service, only the suppliers located in the immediate vicinity of the user are selected automatically.

Further user support is achieved in that the stored contents of the data sources are classified and sorted or selected according to pre-selected criteria. These criteria can either be entered by the user via his terminal or are already contained in the database of the user-specific data. Using the example already given above, certain taste preferences of the user can be used to classify and sort the data and these presented clearly in blocks to the user.

According to a further characteristic feature of the invention the user-specific selection of a particular data source is stored. This additional information can firstly contribute to increasing the quality of the selection of future information and secondly also be useful to suppliers of different information in the data networks. For example access to the information of certain suppliers can be recorded and from this conclusions drawn concerning particular preferences of the user.

Preferably, statistical data are stored to facilitate or allow various analyses or calculations of fees or discounts.

The dialog between a user and a data source can also be supported by the use of user-specific data which is simply stored. Thus when ordering a pizza over the Internet the personal data of the user such as for example the address, telephone number or preferred sizes, which are simply stored, can be automatically transferred to the data source in particular the home page of the pizza service on the Internet, while these no longer need be input and thus time can be saved.

The dialog between the user and the database preferably takes place using Hypertext Transfer Protocol (HTTP) or Simple Object Access Protocol (SOAP) and the documents transferred preferably correspond to the Extensible Markup Language (XML) standard. This format is characterized in that the content and formatting of the data are separated and thus simple representation can be implemented easily even on small terminals e.g. mobiles or Palms or the like.

The dialog between the database and the data source in the data network, in particular the Internet, advantageously takes place using Hypertext Transfer Protocol (HTTP) or Simple Object Access Protocol (SOAP) and the documents transferred preferably correspond to the Hypertext Markup Language (HTML) or Extensible Markup Language (XML) standard. These are commonly used formats on the Internet. Also devices or methods for conversion of the standard or formats concerned can be provided.

To achieve the object according to the invention a computer device is also used to provide pre-selected information from at least one data network, in particular the Internet, for a terminal of a user with a connection to the data network and with a connection to the terminal, where the terminal has input means and output means and is equipped with a database for storage of certain contents, to query certain data sources offered by selected suppliers on the data network, in particular websites, which contents are queried by input or selection of search terms referring to required products, services or information from suppliers via the input means of the terminal and can be output at the output means of the terminal. Such a computer device in the simplest case consists of a computer connected to the data network. Also a group of computers can be used to provide pre-selected information.

The terminals can be personal computers but also other devices which allow connection to the data network concerned. For example mobile telephones, but also video recorders, DVD players or even Internet-compatible watches or domestic appliances can serve as terminals. The input means may be a keypad, speech input or similar. The output means are either an optical display or an acoustic output device. For example by pressing a key on a mobile telephone or Palm, the pizza services in the area can be listed on the display.

In order to allow targeted use of user-specific data, identification means are provided to identify the user of the terminal. As a result user data can be clearly allocated to the user concerned. Thus it is also possible to identify various users via one and the same terminal. When the terminal is used by just one user, identification can be automatic, for example via the telephone number of a mobile phone.

To guarantee confidential use in particular of user-specific data, according to a further feature of the invention encryption and decryption means are provided for encryption and decryption of the connection to the terminal. Various coding and decoding or encryption and decryption methods according to the state of the art can be used.

If a database is provided to store user-specific data, a further more targeted selection can take place but also classification or sorting of the information provided by the computer device. In addition, the user-specific data stored in the database can be used for other purposes.

Moreover, a database can be provided for storing statistical data which can offer important information firstly to the user and secondly to the operator of the computer device and the various suppliers. The database for storage of pre-selected information of the data sources and the database for storing user-specific data and the database for storing statistical data can be combined in one database.

Advantageously, means are provided for sorting or selecting the stored contents. These means, normally implemented by software, can sort or select the available databases by particular criteria, so that the user is supported even more. In this way for example various pizza services can be sorted by price or delivery time of the meals.

If the computer device contains means for combining user-specific data and selected contents and also means for passing on the combined data to a data source, this further facilitates the dialog of the user with a particular data source, in particular a website on the Internet. In this way it is possible for example to combine personal data of the user with the stored information of a pizza service and then pass the correspondingly combined data record on as an order to the home page of the pizza service.

The connection between the terminal and the computer device or data network advantageously takes place cableless, so that it is not necessary to have a wired connection to the data network. The cableless connection can for example be formed by a radio link of a mobile telephone or by an infrared link of a terminal with the modem of a data network.

In order to provide the optimum format of the stored contents, a device for converting the format of the stored contents is provided in the computer device or in the terminal. Thus the contents provided can be output on the terminal in optimum fashion.

In the terminal a database can be provided for storing selected contents of the database of the computer device so that the required information is quickly available without loss of time for data transfer between the computer device and the terminal. The database in the terminal is advantageously compared in cycles with the content of the database in the computer device and where applicable overwritten.

The terminal input means can also be formed by a speech input device and where applicable the output means by a speech output device. This facilitates the operation for the user even more.

Instead of or in addition to the speech output, a graphics display can serve as an output means of the terminal.

To achieve the object according to the invention a computer program product is used which can be loaded in the memory of a digital computer and which comprises software code sections, while the computer can process the steps of the method described above when the product is running on the computer.

The software code sections of the computer program product are here preferably stored on a computer-legible medium.

The invention will be further described with reference to examples of embodiment shown in the drawings to which, however, the invention is not restricted. Here:

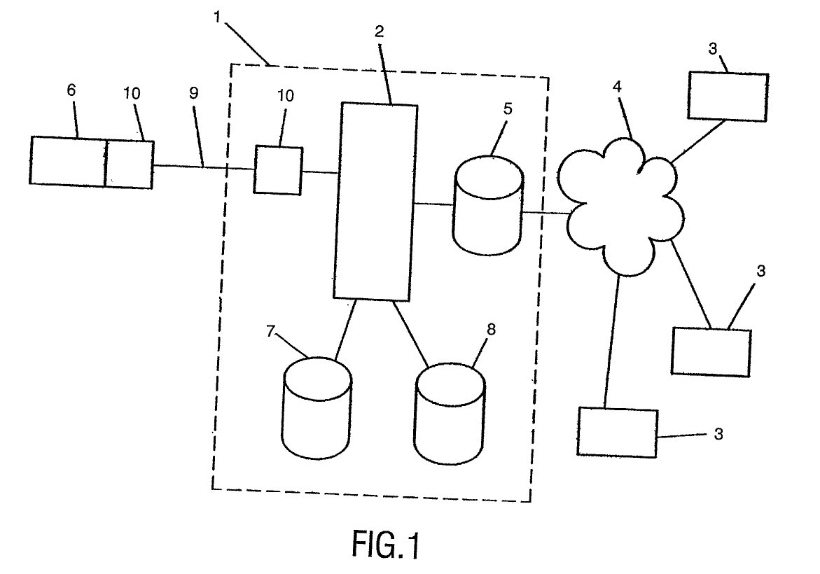

FIG. 1 diagrammatically shows the function of the method to provide pre-selected information from a data network, and

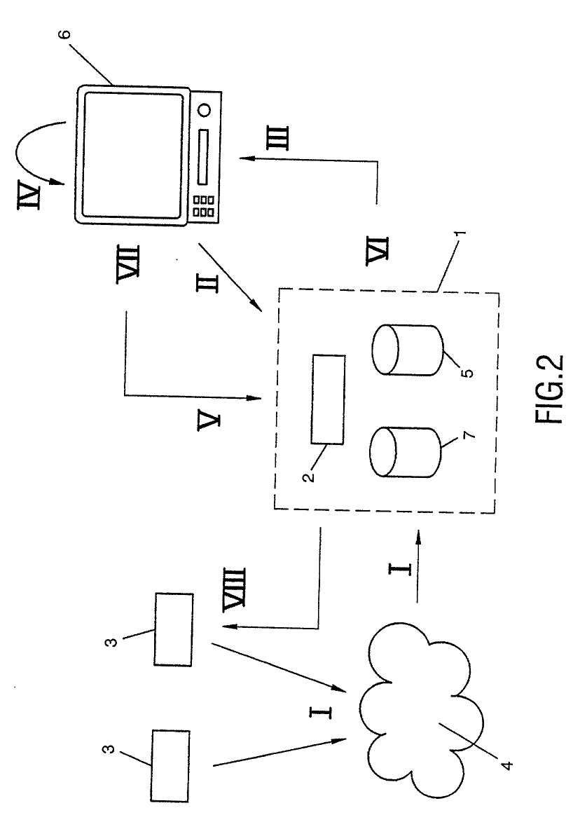

FIG. 2 shows an example for the use of the method in ordering a pizza or the like over the Internet.

FIG. 1 diagrammatically shows the function principle of the method to provide pre-selected information from data networks. A computer device 1 contains at least one computer 2 which queries the various data sources 3 in a data network 4, in particular the Internet, and stores predetermined contents of these data sources 3 in a database 5. The database 5 contains predetermined contents of several data sources 3 which offer a particular product, service or information. By input or selection of a search term referring to desired products, services or information from the suppliers via a terminal 6, a user can quickly find a selection of information from various data sources 3 without having to know the actual data source 3 in the data network 4. A further advantage of the invention is that the terminal 6 need not fulfil the conditions with regard to computing power, decoding ability or capacity for immediate display of the data from the data source 3, but must merely be able to output or display the pre-selected information. Consequently, terminals 6 such as mobile telephones or Palms can sensibly be used for dialog with the data sources 3 in the data network 4.

A further improvement of the pre-selection of the information can be achieved by taking into account user-specific data which is preferably stored in a database 7. The user-specific data is stored in the database 7 by input via the terminal 6. This may be not only personal data such as name, address, date of birth or the like, but also information on particular user preferences. User-specific data can also be detected automatically for example by recording frequently visited suppliers of products, services or information and stored in the database 7. Furthermore a database 8 could be provided in which are stored statistical data such as frequency of selection of information from certain data sources 3 or similar, and important information supplied firstly to the administrator of the computer device 1 and secondly to the suppliers of various products, services or information and operators of the data sources. The statistical data stored in the database 8 can also be used by the operator of the data sources 3 to charge for the use of the computer device or to give discounts or stimulate purchases. To secure the connection 9 between the terminal 6 and the computer device 1, in both the terminal 6 and the computer device 1 can be provided a device 10 for encryption and decryption of the information. The connection between the terminal 6 and the computer device 1 can also be formed by a mobile telephone network, a data network e.g. the Internet, or a wire or cableless connection.

FIG. 2 shows the application of the method under discussion of ordering a pizza or similar by means of the terminal 6 via the Internet 4. In the database 5 of the computer device 1 is stored for example information from various data sources 3, in this case various pizza services on the Internet 4. To this end according to method step I corresponding data from the data source 3 are stored in the database 5 of the computer device 1 via the Internet 4. Via a terminal 6, for example, a personal computer but also a television, mobile phone or similar, the user can see the information supplied by the computer device 1. To this end the user enters search terms referring to desired products or services from suppliers via the terminal 6. Instead of the user entering search terms via the terminal 6, the computer device 1 can also offer a list of possible search terms or products or services or information to be selected and show this on the display of the terminal 6. The information comprises the data of the data source 3 which are relevant to the user concerned. The user is offered, for example, only the pizza services in his immediate vicinity. Then the user can target his search according to method step 1I on the computer device 1, in which the information provided by the computer device 1 and stored in the database 5 can be selected, classified or sorted and displayed on the display of the terminal 6 (method step III). In the next method step IV, the user selects via the terminal 6 a particular product, in this case a particular pizza or similar. The order is supplemented with user-specific data which can already be located in a database 7 of the computer device 1 and transferred to the computer device 1 (method step V).

According to method step VI the computer device 1 determines from the information stored in database 5 which pizza service can supply the selected pizza in what delivery time and at what price. A list with the selected information is transferred to the terminal in method step VI. In method step VII the user selects one of the pizza services offered and the terminal 6 transmits the selection to the computer device 1. After confirmation of the order this is transferred in method step VIII to the selected data source 3 or website on the Internet 4, whereupon the order for the corresponding pizza or similar is concluded. In any case the pizza service would still confirm the order from the user by telephone in the conventional manner. In this case the user need not have knowledge of the Internet addresses of various pizza services but must merely have a connection to the computer unit 1 and express his wish or select the required product there. The computer device 1 performs the time-consuming work of searching for the user for corresponding data sources 3 in the data network 4, in particular the Internet. In addition, the information stored in the database 5 can be sorted or selected by particular criteria. User-specific information stored in the database 7, or inputs made by the user by the terminal 6, can be used for sorting or selection of the data. For example by entering an upper limit for the delivery time a further selection of possible pizza services can be made and the user's selection thus facilitated.

Apart from the example of ordering a pizza, widely varying applications are possible e.g. finding particular events, accommodation in a particular town, transport connections or much more.

It may be stated that with the computer device according to the invention the implementation of a method of doing business also according to the invention is possible. The computer device can then collect orders from terminals that have approximately the same delivery address. With such orders the delivery address would be for example the same residential building or adjacent residential buildings. For such orders the computer device could automatically or the operator of the computer device could apply an additional discount to the price of the products ordered, so that the end client by using the computer device advantageously needs to pay only a lower price for the product ordered.

It may be stated that with the computer device according to the invention the implementation of a further method of doing business according to the invention is made possible. When a supplier of products or services who operates one of the data sources connected to the data network pays an advertising fee to the operator of the computer device, then according to the method of doing business the product of this supplier is shown to the end client first in the list of possible suppliers of the desired product in process step VI. This gives this supplier a greater chance of having his product ordered.

It may be stated that, even after confirmation of the order by the end client, the computer device can transmit information which identifies the status of delivery (product is made, packed, in delivery or has been delivered) to the terminal, which is also highly advantageous.

1. A method to provide pre-selected information from at least one data network (4) more particularly the Internet, for querying by a user terminal (6), in which certain data sources (3) offered by selected suppliers in the data network (4), more particularly websites, are queried and particular contents of these data sources (3) are stored, which contents can be queried and output via the terminal (6) by input or selection of search terms referring to desired products, services or information from suppliers.

2. A method as claimed in claim 1, in which the selected data sources (3) are queried periodically.

3. A method as claimed in claim 1, in which user-specific data can also be entered and stored via the terminal (6) in addition to the contents of the data sources (3).

4. A method as claimed in claim 1, in which the stored contents of the data sources (3) are classified and sorted or selected by selected criteria.

5. A method as claimed in claim 1, in which the user-specific selection of a particular data source (3) is stored.

6. A method as claimed in claim 1, in which statistical data are stored.

7. A method as claimed in claim 1, in which user-specific data are used for a dialog between the user and a data source (3).

8. A method as claimed in claim 1, in which the user-specific data are combined with data that have been input.

9. A method as claimed in claim 1, in which the dialog between user and database (5) takes place via Hypertext Transfer Protocol (HTTP) or Simple Object Access Protocol (SOAP) and the transferred documents correspond to the Extensible Markup Language (XML) standard.

10. A method as claimed in claim 1, in which the dialog between user and database (5) takes place via Hypertext Transfer Protocol (HTTP) or Simple Object Access Protocol (SOAP) and the transferred documents correspond to the Extensible Markup Language (XML) standard or Hypertext Markup Language (HTML) standard.

11. A computer device (1) for provision of pre-selected information from at least one data network (4), more particularly the Internet, for querying by a user terminal (6), with a connection to the data network (4) and a connection (9) to the terminal (6), where the terminal (6) has input means and output means, and with a database (5) for storing contents of certain data sources (3) offered by selected suppliers in the data network (4), in particular websites, which contents are queried via input or selection of search terms referring to desired products, services or information of suppliers via the input means of the terminal (6) and can be output via the output means of the terminal (6).

12. A computer device as claimed in claim 11, in which identification means are provided to identify the user of the terminal (6).

13. A computer device as claimed in claim 11, in which encryption and decryption means (10) are provided for encryption and decryption of the connection (9) to the terminal (6).

14. A computer device as claimed in claim 11, in which a database (7) is provided to store user-specific data.

15. A computer device as claimed in claim 11, in which a database (8) is provided to store statistical data.

16. A computer device as claimed in claim 11, in which means are provided for sorting or selecting the stored contents.

17. A computer device as claimed in claim 11, in which means are provided for combining user-specific data and selected contents and also means for passing on the combined data to a data source (3).

18. A computer device as claimed in claim 11, in which the connection (9) to the terminal (6) is cableless.

19. A computer device as claimed in claim 11, in which a device is provided for converting the format of the stored contents.

20. A computer device as claimed in claim 11, in which the terminal (6) contains a database for storing selected contents of the databases (5, 7, 8).

21. A computer device as claimed in claim 11, in which the input means of the terminal (6) are formed by a speech input unit and the output means by a speech output unit.

22. A computer device as claimed in claim 11, in which the output means are formed by a graphics display.

23. A computer program product which can be loaded in the memory of a digital computer and comprises software code sections to perform the method as claimed in any of claims 1 to 10, when the product runs on the computer.

24. A computer program product as claimed in claim 23, in which the software code sections are stored on a computer-readable medium.
